(19) United States
(12) Patent Application Publication
(10) Pub. No.: US 2024/0320960 A1
(43) Pub. Date: Sep. 26, 2024

(54) SYSTEM AND METHOD FOR JUDGMENT USING DEEP LEARNING MODEL

(71) Applicant: QURAM Co.,LTD., Yongin-si (KR)

(72) Inventor: Young Cheul WEE, Suwon-si (KR)

(21) Appl. No.: 18/608,976

(22) Filed: Mar. 19, 2024

(30) Foreign Application Priority Data
Mar. 24, 2023 (KR) 10-2023-0038706
Mar. 18, 2024 (KR) 10-2024-0036973

(51) Int. Cl. G06V 10/774; G06V 10/82

(52) U.S. Cl. CPC G06V 10/774; G06V 10/82

(57) ABSTRACT

Disclosed is a system and method for judgment using deep learning model, the method for judgment using a deep learning model includes steps of outputting a predetermined judgment result when an image is input, the method comprising the steps of: receiving a target image for judgment, by a system; generating a difference image based on the received target image, wherein the difference image is an image whose pixel values are the difference values between a pixel in the target image and one of its surrounding pixels, by the system; converting the target image into frequency domain information, by the system; and inputting the difference image and the frequency domain information into the deep learning model and acquiring the judgment result output from the deep learning model, by the system.

### TECHNICAL FIELD

The present invention relates to a system and method for judgment using a deep learning model, and more specifically, a system and method that are effective in performing a predetermined judgment on images by training a deep learning model capable of making such judgments.

### BACKGROUND ART

The use of neural network-based deep learning methods is widespread across various fields.

Particularly, the deep learning method using neural networks (for example, Convolution Neural Network, CNN) has been extensively researched for its ability to extract features from images (or objects) without the need for manual identification by users, and using these features to achieve highly accurate judgment (or inference) results.

Such deep learning judgment applications vary depending on the required task for the image, including text recognition (OCR) on objects, classification of images (for example, diagnosis of pathological images), and authenticity verification of objects (for example, verifying the authenticity of identification documents), among others. Preparing training data according to the required tasks and training deep learning models accordingly have been widely used in various fields.

It is known that image-based deep learning models can achieve higher recognition performance when a certain preprocessing step is conducted to allow the neural network to better learn the features.

During this preprocessing step, it might be preferable to enhance the features of the image that are robust against noise such as lighting and background or to weaken unnecessary features.

### DOCUMENT OF PRIOR ART

Korean Patent Publication No. 10-2015-0099116 “Color character recognition method and device using OCR”

### SUMMARY

### Technical Problem to be Solved

Therefore, the present invention has been made in view of the above problems, and it is an object of the present invention to provide a method and system for performing a predetermined judgment using an image-based deep learning model that can achieve high performance.

In particular, it is an object of the present invention to provide a learning method for a deep learning model and a judgment method using the same that can exhibit high performance in recognizing and/or judging hard-to-see features while being robust against external environments.

### Technical Solution

To accomplish the above object, according to one aspect of the present invention, there is provided a method for judgment using a deep learning model outputting a predetermined judgment result when an image is input, the method comprising the steps of: receiving a target image for judgment, by a system; generating a difference image based on the received target image, wherein the difference image is an image whose pixel values are the difference values between a pixel in the target image and one of its surrounding pixels, by the system; converting the target image into frequency domain information, by the system; and inputting the difference image and the frequency domain information into the deep learning model and acquiring the judgment result output from the deep learning model, by the system.

The method further comprises: training the deep learning model, by the system; wherein the step of training the deep learning model includes receiving training target images and labeling values as training data, generating training target difference images corresponding to the training target images, and inputting the generated training target difference images, frequency domain information of the training target images, and the labeling values into the deep learning model as training data, by the system.

The target image for judgment can be a specific object, and the judgment result is characterized by being based on the material of the object, by the system.

To accomplish the above object, according to another aspect of the present invention, there is provided A learning method for a deep learning model comprising: receiving training target images and labeling values, by a system; generating training target difference images corresponding to the training target images, by the system; inputting the generated training target difference images, frequency domain information of the training target images, and the labeling values into the deep learning model as training data, by the system.

The method may be implemented by a computer program installed in a data processing device.

To accomplish the above object, according to another aspect of the present invention, there is provided a system for performing judgment using a deep learning model outputting a predetermined judgment result when an image is input, the system comprising: a processor; and a memory storing a program driven by the processor, wherein the processor operates the program to receive a target image for judgment, generate a difference image based on the received target image, wherein the difference image is an image whose pixel values are the difference values between a pixel in the target image and one of its surrounding pixels, convert the target image into frequency domain information, and input the converted frequency domain information and the difference image into the deep learning model to acquire the judgment result output from the deep learning model.

To accomplish the above object, according to another aspect of the present invention, there is provided a system for training a deep learning model outputting a predetermined judgment result when an image is input, the system comprising: a processor; and a memory storing a program driven by the processor, wherein the processor operates the program to receive training target images and labeling values, generate training target difference images corresponding to the training target images, and input the generated training target difference images, frequency domain information of the training target images, and the labeling values into the deep learning model as training data.

### Advantageous Effects

According to the spirit of the present invention, by using difference images and frequency domain information, it is possible to construct and utilize a deep learning model that can perform highly effective recognition and/or judgment of features that are difficult to visually detect, such as high-frequency image features, while being robust against external environment or intrinsic properties of the image (such as form or shape).

### BRIEF DESCRIPTION OF THE DRAWINGS

To more sufficiently understand the drawings cited in the detailed description of the present invention, a brief description of each drawing is provided.

FIG. 1 is a view schematically showing a system configuration for implementing the judgment method using a deep learning model according to the spirit of the present invention.

FIG. 2 is a physical configuration of a judgment system using a deep learning model according to an embodiment of the invention.

FIG. 3 is a schematic flowchart explaining the judgment method using a deep learning model according to an embodiment of the invention.

FIG. 4 is a flowchart explaining the learning method of a deep learning model according to an embodiment of the invention in a schematic manner.

FIG. 5 is a concept of the judgment method using a deep learning model according to an embodiment of the invention.

### DETAILED DESCRIPTION OF EXEMPLARY EMBODIMENTS

Since the present invention may be diversely converted and have various embodiments, specific embodiments will be shown in the drawings and described in detail in the detailed description. However, it should be understood that this is not intended to limit the present invention to the specific embodiments, but to comprise all conversions, equivalents and substitutions included in the spirit and scope of the present invention. In describing the present invention, if it is determined that the detailed description on the related known art may obscure the gist of the present invention, the detailed description will be omitted.

The terms such as “first” and “second” can be used in describing various constitutional components, but the above constitutional components should not be restricted by the above terms. The above terms are used only to distinguish one constitutional component from the other.

The terms used herein are used only to describe particular embodiments and are not intended to limit the present invention. A singular expression includes a plurality of expressions, unless the context clearly indicates otherwise.

In this specification, it should be further understood that the terms “include” and “have” specify the presence of stated features, numerals, steps, operations, constitutional components, parts, or a combination thereof, but do not preclude the presence or addition of one or more other features, numerals, steps, operations, constitutional components, parts, or a combination thereof.

In addition, in this specification, when any one of constitutional components “transmits” a data to another constitutional component, it means that the constitutional component may directly transmits the data to another constitutional component or may transmit the data to another constitutional component through at least one of the other constitutional components. On the contrary, when any one of the constitutional components directly transmits a data to another constitutional component, it means that the data is transmitted to another constitutional component without passing through the other constitutional components.

Hereinafter, the present invention is described in detail focusing on the embodiments of the present invention with reference to the attached drawings. Like reference symbols presented in each drawing denote like members.

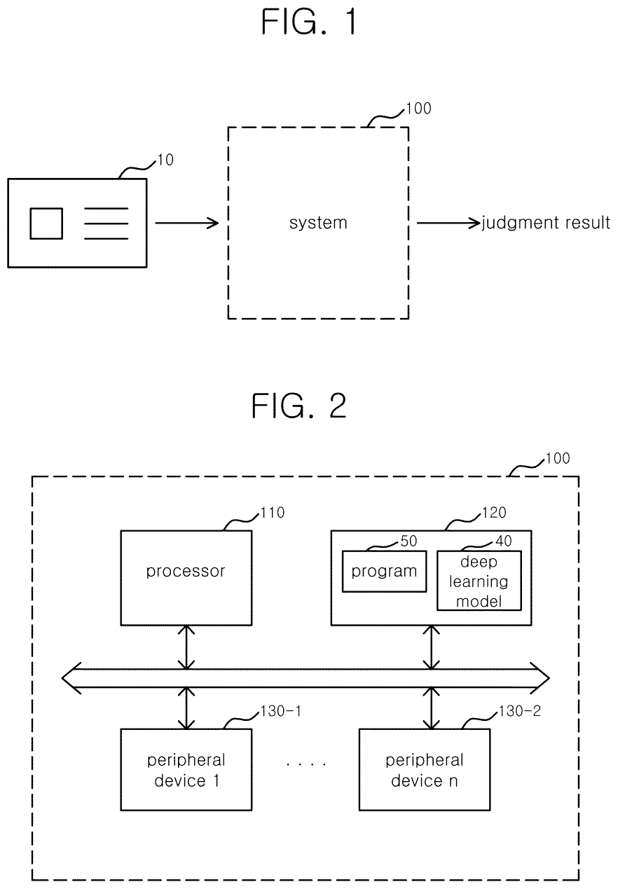

FIG. 1 is a view schematically showing a system configuration for implementing the judgment method using a deep learning model according to the spirit of the present invention. Additionally, FIG. 2 shows a physical configuration of a judgment system using a deep learning model according to an embodiment of the invention.

Referring to FIG. 1, to implement a judgment method using a deep learning model according to the technical spirit of the invention, a judgment system (100) can be implemented. The judgment system (hereafter, “the system”, 100) can be installed in a certain data processing system to implement the technical spirit of the invention.

The data processing system signifies a system capable of implementing the technical spirit of the invention, including not only network servers accessible by clients through the network but also any systems capable of making a predetermined judgment and/or training the deep learning model according to the technical spirit of the invention, such as personal computers and portable terminals. It would be readily inferred by those skilled in the art that any system capable of performing such tasks can be defined as the data processing system described in this specification.

In this specification, the judgment using the deep learning model can mean performing tasks desired by the user on images. The judgment can include various tasks such as recognizing text contained in images, detecting predetermined objects, classifying images or objects, etc.

For example, the system 100 could be a system that acquires an image of an identification (e.g., ID card) and outputs a judgment result corresponding to the authenticity of the identification based on the acquired image. However, this is merely illustrative, and the technical spirit of the invention can be applied to various embodiments capable of performing a predetermined judgment based on images.

For instance, if the system 100 uses both the difference image and frequency domain information to determine authenticity, the judgment based on the difference image can robustly display the edges marked on the identification against external environments. This allows for judgment based on the unique features of the image (such as the edges of letters, drawings, etc.) while simultaneously considering the material characteristics of the identification based on the frequency domain information, enabling more accurate judgment.

The system 100 can be installed in a certain data processing system (e.g., portable terminal) to implement the technical spirit of the invention as defined in this specification.

The system 100 means a system where the hardware of the data processing system and the program (application) to perform the functions defined in this specification are organically combined. If necessary, the system 100 can be organically combined with a certain server (not shown), and in this case, certain operations can be performed by the server. In this scenario, the system 100 may include the server (not shown). For example, the system 100 may perform a process to output a predetermined judgment result using the hardware resources of the portable terminal, but if necessary, the judgment process to output the judgment result may also be performed through the server (not shown). In such cases, the system 100 can be defined to include the server (not shown). Of course, if necessary, the act of receiving the judgment result from the server for the judgment process can also be defined as the system 100 performing the judgment process.

Hereinafter, when it is said that the system 100 performs a certain function in this specification, it means that the program to implement the technical spirit of the invention drives the hardware of the data processing system to perform the function.

The system 100 can be equipped with a memory (storage device) 120 where the program 50 for implementing the technical spirit of the invention is stored, and a processor 110 to execute the program stored in the memory 120. Additionally, the deep learning model 40 trained according to the technical spirit of the invention can be stored in the memory 120. Depending on the embodiment, the system 100 can be implemented as multiple physical devices, with the program 50 stored in the first physical device and the deep learning model 40 stored in the second physical device, communicating organically to implement the technical spirit of the invention.

The program 50 can perform a certain preprocessing on the target image for judgment (e.g., an identification image) according to the technical spirit of the invention. After performing such preprocessing, the preprocessed target image can be input into the deep learning model 40 to receive a judgment result.

If necessary, the program 50 can also control devices (e.g., cameras, etc.) provided in the data processing system (e.g., portable terminal). For example, the program 50 can control the camera to photograph a specific object (e.g., an identification) to acquire the target image for judgment. Of course, the target image for judgment can also be photographed by a separate device and input into the system 100.

According to one embodiment, the program 50 can perform a process to train the deep learning model 40. In this case, preprocessing can also be performed. Of course, the training of the deep learning model 40 can be performed separately, and the program 50 can only perform the process of obtaining the judgment result after preprocessing through the trained deep learning model 40.

The preprocessing according to the technical spirit of the invention can include a process to create a difference image corresponding to the target image for judgment. The preprocessed difference image and/or converted frequency domain information of the target image for judgment can be processed as input information into the deep learning model 40.

The difference image can be an image where the pixel values are the difference values between each pixel in the target image and one of its surrounding pixels. Various embodiments can determine which surrounding pixel, or target pixel, to use as the difference value for the pixel value of the difference image.

For example, the pixel immediately adjacent to a specific pixel in the x-axis (and/or y-axis) direction can be fixed as the target pixel. Alternatively, the pixel diagonally located in a specific direction from a specific pixel can be fixed as the target pixel.

Depending on the embodiment, the target pixel can be adaptively selected based on the image. That is, for some images, a certain pixel adjacent in the x-axis can be selected as the target pixel, and for other images, a certain pixel adjacent in the y-axis can be selected as the target pixel.

The target pixel can be selected in various ways for each pixel, and the difference image can be created based on the difference values between the selected target pixels and the specific pixels.

When using the difference image to train and infer the deep learning model, characteristics robust against external environments (e.g., lighting or brightness of light) can be achieved. That is, the unique features of images can be enhanced while being less affected by external environments.

Additionally, the system 100 can perform preprocessing not only to create the difference image but also to convert the original image, that is, the target image for judgment, into frequency domain information. That is, the converted frequency domain information can be further used as input data for inference or training in the deep learning model 40. Of course, depending on the embodiment, either the difference image or the frequency domain information may be selectively used as input data.

This frequency domain information can be generated through transformation algorithms widely known, such as Discrete Cosine Transform (DCT) or Fourier Transform (Fourier transform).

Using the frequency domain information of the target image for judgment as input to the deep learning model 40, very advantageous effects can be achieved in cases where certain attributes of the image appear more prominently in specific frequency bands.

For example, the material characteristics of an image can be more accurately judged when the frequency domain information of the target image for judgment is used as input to the deep learning model 40, rather than when the image itself or the difference image is input into the deep learning model 40. This is because features such as material characteristics are typically represented more prominently in the high-frequency (high frequency) area compared to other frequency bands, and thus, using frequency domain information as input to the deep learning model 40 can be much more advantageous for features that are well represented in certain frequency bands.

Additionally, if necessary, not the frequency domain information of the target image for judgment itself but the frequency domain information of the difference image can be used as input to the deep learning model 40. This case can occur because features of images (e.g., features important for judging the material) can be significantly affected by external environments, and it is robust to make judgments focusing on the unique features of the target image for judgment while also considering that the characteristics of these unique features are well represented in certain frequency bands.

Therefore, according to an embodiment of the invention, when performing a specific task based on an image, the information that can be used as input to the deep learning model 40 can be the difference image and/or frequency domain information of the target image for judgment, and if necessary, the frequency domain information of the difference image can also be used as additional input.

Consequently, the judgment method using a deep learning model according to the technical spirit of the invention does not use the target image for judgment itself as input to the deep learning model 40, but uses the difference image and/or frequency domain information of the target image for judgment as input, enabling the use of features that have a significant impact on the judgment to be effectively utilized by the deep learning model, leading to more accurate judgments.

This effect can be commonly applied when the judgment to be performed through the deep learning model 40 is based on characteristics that are intensively enhanced in specific frequency bands in the frequency domain or when a judgment robust against external environments is needed.

The processor 110 included in the system 100 for implementing this technical spirit can be named variously, such as CPU, GPU, and/or mobile processor, depending on the implementation example of the authentication system 100, as would be readily inferred by those skilled in the art. As mentioned above, the system 100 can be implemented by organically combining multiple physical devices, and in such cases, at least one processor 110 can be equipped in each physical device to implement the system 100, as would be readily inferred by those skilled in the art.

The memory 120 stores the deep learning model 40 and/or the program 50 and can be implemented in any form of storage device accessible by the processor 110 to perform the functions defined in this specification. Depending on the hardware implementation example, the memory 120 can be implemented not as a single storage device but as multiple storage devices. Additionally, the memory 120 can include not only primary memory but also temporary memory. It can be implemented as volatile memory or non-volatile memory and is defined to include all forms of information storage means that can be stored and driven by the processor.

Furthermore, various peripheral devices (Peripheral 1 to Peripheral N, 130-1, 130-2) can be additionally equipped according to the embodiment of the system 100. For example, a keyboard, monitor, graphics card, communication device, etc., can be included as peripheral devices in the system 100, as would be readily inferred by those skilled in the art.

Hereinafter, when it is said that the system 100 performs a certain function in this specification, it means that the processor 110 drives the program 50 and/or the deep learning model 40 provided in the memory 120 to perform the function, as would be readily inferred by those skilled in the technical field of the invention.

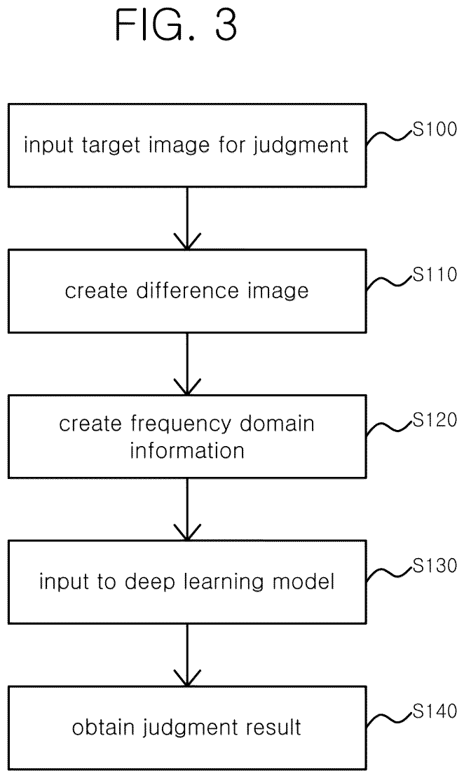

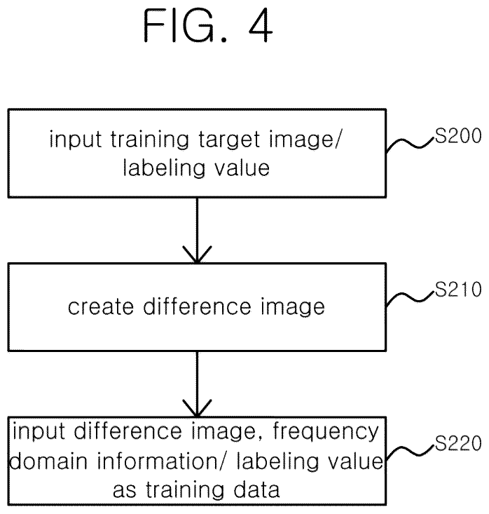

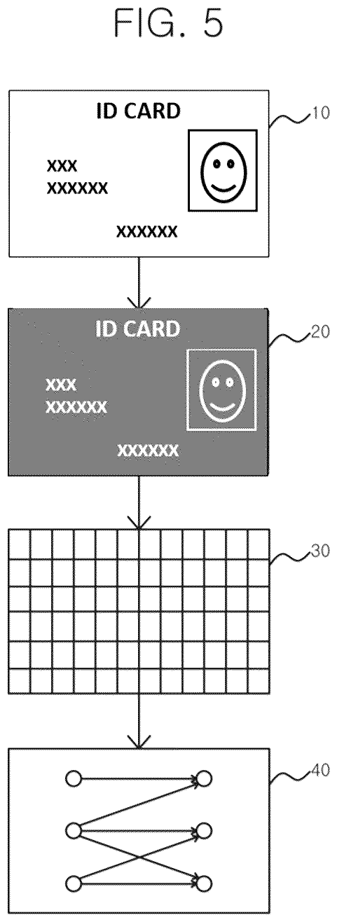

FIG. 3 is a schematic flowchart explaining the judgment method using a deep learning model according to an embodiment of the invention. Additionally, FIG. 4 is a flowchart explaining the learning method of a deep learning model according to an embodiment of the invention in a schematic manner. And FIG. 5 is a concept of the judgment method using a deep learning model according to an embodiment of the invention.

Referring to FIGS. 3 to 5, as previously mentioned, the system (100) can receive a target image for judgment (S100).

As shown in FIG. 5, the target image for judgment 10 can be an image of a specific object (e.g., an identification(ID card)) but is not limited to this and can be applied to various objects according to the technical spirit of the invention.

The system 100 can directly acquire the target image for judgment by controlling the camera and photographing it, or it can simply receive or be transmitted the target image for judgment 10 from another source.

Then, the system 100 can create a difference image 20 corresponding to the target image for judgment 10 (S110).

The difference image 20 shown in FIG. 5 is an example of an image created by selecting one of the pixels adjacent in the x-axis direction from the surrounding pixels for each pixel included in the target image for judgment 10. However, it does not need to be limited to this, as mentioned previously.

Additionally, as shown in FIG. 5, once the difference image 20 is created, the form or shape of the image itself is significantly weakened, and specific components, such as edges, are selectively strengthened. This characteristic allows for the predetermined inference (judgment) to be performed robustly against external environments or types of images.

Furthermore, the system 100 can create frequency domain information 30 corresponding to the target image for judgment 10 (S120).

As mentioned previously, certain meaningful features in the image can be prominently represented in specific bands of the generated frequency domain information 30. For example, features related to the material of the identification 10 may appear well in the relatively high-frequency bands of the frequency domain information 30. For instance, the pattern that appears when the material of the identification in the image 10 is a first material (e.g., plastic) may differ significantly from the pattern that appears when it is a second material (e.g., paper, monitor, etc.), and this difference may appear well in the information of the high-frequency bands. That is, when the surface properties of objects are different, the differences may be well represented in the information corresponding to the high-frequency bands of the frequency domain information, and therefore, the effects of the technical spirit of the invention can be greater for features that can be enhanced in such high-frequency bands.

Then, the system 100 can input the created difference image and/or frequency domain information 30 into the deep learning model 40 (S130), and in response, it can obtain a predetermined judgment result from the deep learning model 40 (S140).

The judgment result, for example, can be a judgment result determined based on the material of the object (e.g., an identification document). For instance, if the material of the identification included in the identification image 10 corresponds to plastic, paper, etc., each of these materials can be defined as corresponding classes, and a multi-class classification model that outputs one of these classes as the judgment result can be the deep learning model 40. Then, the judgment result can be the result of classifying into one of the classes.

Alternatively, regarding the material, a binary class classification model that classifies whether the object (e.g., an identification document) corresponds to a specific material or another material can be used, and in this case, the judgment result can be one of the two classes.

Furthermore, the deep learning model 40 can be trained in various ways to output a certain judgment result, and based on the trained method, it can output the judgment result, as would be readily inferred by those skilled in the technical field of the invention.

Meanwhile, the preprocessing method of the system 100 for the target image for judgment 10 during the judgment process (inference process) can also be similarly applied when training the deep learning model 40.

As shown in FIG. 4, the system 100 can receive training target images and their labeling values (S200). For example, if the system 100, as previously mentioned, outputs judgment results related to the material of identification documents, the system 100 can use numerous training target images (e.g., identification document images) and their labeling values (e.g., materials such as plastic, paper, monitor, etc.) as the basis for training data for the deep learning model 40.

Then, the system 100 can create difference images for each of the training target images (S210).

And the system 100 can input the difference images and the frequency domain information of the training target images, matched with the received labeling values, into the deep learning model 40 as training data, allowing training to be performed (S220).

The deep learning model 40, trained in this manner, can, as mentioned previously, create a difference image when a target image for judgment is input, and input the created difference image and the frequency domain information of the target image for judgment as input data into the deep learning model 40. Then, the trained deep learning model 40 can output a judgment result based on the input data according to the trained neural network.

Ultimately, according to the technical spirit of the invention, by utilizing the difference image, the possibility of errors in judgment results due to external environments and types of images is reduced. Simultaneously, by utilizing characteristics that can well represent features (e.g., material of the object) that directly influence the judgment result in certain frequency bands in the frequency domain, it is possible to achieve highly accurate judgments in making decisions based on these features.

Additionally, although the specification exemplifies cases where the object is an identification and the judgment is based on the material of the object, the technical spirit of the invention can be applied to any object and/or features that can be well represented in certain frequency bands, as would be readily inferred by those skilled in the technical field of the invention.

The judgment method using deep learning model according to an embodiment of the present invention can be implemented as a computer-readable code in a computer-readable recording medium. The computer-readable recording medium includes all kinds of recording devices for storing data that can be read by a computer system. Examples of the computer-readable recording medium are ROM, RAM, CD-ROM, a magnetic tape, a hard disk, a floppy disk, an optical data storage device and the like. In addition, the computer-readable recording medium may be distributed in computer systems connected through a network, and a code that can be read by a computer in a distributed manner can be stored and executed therein. In addition, functional programs, codes and code segments for implementing the present invention can be easily inferred by programmers in the art.

While the present invention has been described with reference to the embodiments shown in the drawings, this is illustrative purposes only, and it will be understood by those having ordinary knowledge in the art that various modifications and other equivalent embodiments can be made. Accordingly, the true technical protection range of the present invention should be defined by the technical spirit of the attached claims.

1. A method for judgment using a deep learning model outputting a predetermined judgment result when an image is input, the method comprising the steps of:
receiving a target image for judgment, by a system;
generating a difference image based on the received target image, wherein the difference image is an image whose pixel values are the difference values between a pixel in the target image and one of its surrounding pixels, by the system;
converting the target image into frequency domain information, by the system; and
inputting the difference image and the frequency domain information into the deep learning model and acquiring the judgment result output from the deep learning model, by the system.

2. The method according to claim 1, wherein the method further comprises:
training the deep learning model, by the system;
wherein the step of training the deep learning model includes receiving training target images and labeling values as training data, generating training target difference images corresponding to the training target images, and inputting the generated training target difference images, frequency domain information of the training target images, and the labeling values into the deep learning model as training data, by the system.

3. The method according to claim 1, wherein the target image for judgment is a specific object, and the judgment result is characterized by being based on the material of the object, by the system.

4. A learning method for a deep learning model comprising:
receiving training target images and labeling values, by a system;
generating training target difference images corresponding to the training target images, by the system;
inputting the generated training target difference images, frequency domain information of the training target images, and the labeling values into the deep learning model as training data, by the system.

5. A computer program recorded on a computer-readable recording medium for performing the method according to the claim 1.

6. A system for performing judgment using a deep learning model outputting a predetermined judgment result when an image is input, the system comprising:
a processor; and
a memory storing a program driven by the processor,
wherein the processor operates the program to receive a target image for judgment, generate a difference image based on the received target image, wherein the difference image is an image whose pixel values are the difference values between a pixel in the target image and one of its surrounding pixels, convert the target image into frequency domain information, and input the converted frequency domain information and the difference image into the deep learning model to acquire the judgment result output from the deep learning model.

7. A system for training a deep learning model outputting a predetermined judgment result when an image is input, the system comprising:
a processor; and
a memory storing a program driven by the processor,
wherein the processor operates the program to receive training target images and labeling values, generate training target difference images corresponding to the training target images, and input the generated training target difference images, frequency domain information of the training target images, and the labeling values into the deep learning model as training data.
